(19) United States
(12) Patent Application Publication
(10) Pub. No.: US 2026/0009390 A1
(43) Pub. Date: Jan. 8, 2026

(54) BLOWER

(71) Applicant: MILWAUKEE ELECTRIC TOOL CORPORATION, Brookfield, WI (US)

(72) Inventors: John N. WINKLER, Milwaukee, WI (US); Rahul Kumar CHAND, Pewaukee, WI (US); Sophia P. JONAS, Milwaukee, WI (US); Jacob D. HADFIELD, Mukwonago, WI (US); Ming YANG, Dongguan City (CN)

(21) Appl. No.: 19/261,235

(22) Filed: Jul. 7, 2025

Related U.S. Application Data
(60) Provisional application No. 63/668,760, filed on Jul. 8, 2024.

(51) Int. Cl. F04D 25/06; B08B 5/02; F04D 29/58

(52) U.S. Cl. CPC F04D 25/0693; B08B 5/02; F04D 29/584

(57) ABSTRACT

A blower includes a housing defining an inlet and an outlet. The housing extends along a longitudinal axis. The blower also includes a motor within the housing, a printed circuit board assembly having a printed circuit board and a plurality of heat generating electrical components mounted on the printed circuit board, and an impeller coupled to the motor and configured to generate airflow passing along an airflow path from the inlet to the outlet on activation of the motor. The longitudinal axis intersects the motor, the printed circuit board assembly, and the impeller.

### CROSS-REFERENCE TO RELATED APPLICATIONS

This application claims priority to co-pending U.S. Provisional Patent Application No. 63/668,760 filed on Jul. 8, 2024, the entire contents of which is incorporated herein by reference.

### BACKGROUND

Blowers typically include a motor and an impeller for generating airflow, the motor being driven by control electronics which generate heat. Control electronics may be mounted on printed circuit boards.

### SUMMARY

In one independent aspect, a blower includes a housing defining an inlet and an outlet. The housing extends along a longitudinal axis. The blower also includes a motor within the housing, a printed circuit board assembly having a printed circuit board and a plurality of heat generating electrical components mounted on the printed circuit board, and an impeller coupled to the motor and configured to generate airflow passing along an airflow path from the inlet to the outlet on activation of the motor. The longitudinal axis intersects the motor, the printed circuit board assembly, and the impeller.

In another independent aspect, a blower includes a housing, a motor, a printed circuit board assembly, an impeller, and a thermally conductive heat sink. The housing defines a motor housing portion with an inlet and an outlet and a handle portion projecting from the motor housing portion. The motor is positioned within the motor housing portion. The printed circuit board assembly includes a printed circuit board and a plurality of heat generating electrical components mounted on the printed circuit board, the printed circuit board assembly positioned within the handle portion of the housing. The impeller is coupled to the motor and is configured to generate airflow passing along an airflow path from the inlet to the outlet on activation of the motor. The heat sink includes a connection portion thermally coupled to the printed circuit board assembly and a heat dissipation portion positioned in the motor housing portion exposed to the airflow path such that on activation of the motor, the heat generated by the heat generating electrical components is transferred via conduction from the connection portion to the heat dissipation portion and the heat is transferred via convection from the heat dissipation portion to the airflow.

In another independent aspect, a blower includes a housing defining an inlet and an outlet, and a handle portion projecting from the housing portion. The handle portion includes a battery receptacle having a battery terminal with a ground. The blower also includes a motor assembly within the housing. The motor assembly includes a motor case, a motor housing supported with the motor case that has a motor, and a conductor mounted with the motor case. The blower also includes an impeller coupled to the motor and configured to generate airflow passing along an airflow path from the inlet to the outlet on activation of the motor, and a wire electrically coupled to the conductor and the ground on the battery terminal. The wire is configured to route static electricity generated by the motor to the ground of the battery terminal.

Other aspects of the disclosure will become apparent by consideration of the detailed description and accompanying drawings.

### BRIEF DESCRIPTION OF THE DRAWINGS

FIG. 1 is a perspective view of a blower.

FIG. 2 is a cross-sectional view of the blower of FIG. 1 including an adjustable nozzle in an open position.

FIG. 3 is a cross-sectional a blower including a heat sink.

FIG. 4 is a cross-sectional view of a blower including gears between a motor and an impeller.

FIG. 5 is a cross-sectional view of a blower including an auxiliary air inlet.

FIG. 6 is a cross-sectional view of a blower including an impeller downstream of a motor.

FIG. 7 is a cross-sectional view of a blower including an impeller upstream of a motor and a printed circuit board assembly.

FIG. 8 is a cross-sectional view of a blower including a printed circuit board assembly that is oriented transverse to a longitudinal axis of the blower.

FIG. 9 is a cross-sectional view of a blower including a printed circuit board assembly oriented perpendicular to a longitudinal axis of the blower.

FIG. 10 is a cross-sectional view of a blower including an annular printed circuit board assembly.

FIG. 11 is a cross-sectional view of a blower including a printed circuit board assembly positioned in a handle of the blower.

FIG. 12 is a cross-sectional view of a blower including a printed circuit board assembly oriented perpendicular to and offset from a longitudinal axis of the blower.

FIG. 13 is a cross-sectional view of a blower including a printed circuit board assembly positioned in a motor housing portion of the blower downstream of a motor case.

FIG. 14A is a cross-sectional view of the adjustable nozzle of FIG. 2 in a closed position.

FIG. 14B is a side view of the blower and adjustable nozzle of FIG. 2 in the open position.

FIG. 14C is a side view of the blower and adjustable nozzle of FIG. 2 in the closed position.

FIG. 15A is a perspective view of a blower including an adjustable disk in a closed position.

FIG. 15B is an end view of the blower and adjustable disk of FIG. 15A.

FIG. 15C is a cross-sectional view of the blower and adjustable disk of FIG. 15A taken along 15C-15C in FIG. 15B.

FIG. 16A is a perspective view of the blower of FIG. 15A with the adjustable disk in an open position.

FIG. 16B is an end view of the blower and adjustable disk of FIG. 16A.

FIG. 16C is a cross-sectional view of the blower and adjustable disk of FIG. 16A taken along 16C-16C in FIG. 16B.

FIG. 17A is a bottom view of a trigger and shuttle in a lock-off position.

FIG. 17B is a bottom view of the trigger and shuttle of FIG. 17A in an initial operational position.

FIG. 17C is a bottom view of the trigger and shuttle of FIG. 17A in a fully-operated position.

FIG. 17D is a bottom view of the trigger and shuttle of FIG. 17A in a pre-locked-on position.

FIG. 17E is a bottom view of the trigger and shuttle of FIG. 17A in a locked-on position.

FIG. 17F is a perspective view of the trigger and shuttle of FIG. 17A in the lock-off position.

FIG. 18 is a partial-exploded view of a blower according to another embodiment of the present disclosure.

FIG. 19 is cross-sectional view of the blower of FIG. 18.

FIG. 20 is a zoomed-in view of a motor case of the blower of FIG. 18.

FIG. 21 is a zoomed-in, side view of a clip in the motor case of FIG. 20.

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, a trigger structure that is “substantially” in a fully-operated position may be within 10 percent of a range of travel of the trigger structure. For example, the fully-operated position may represent a range between 90 percent operated and 100 percent operated. In such fully-operated positions (e.g., the range between 90 percent operated and 100 percent operated), the trigger structure may be capable of being translated to a pre-locked-on position.

Before any aspects are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

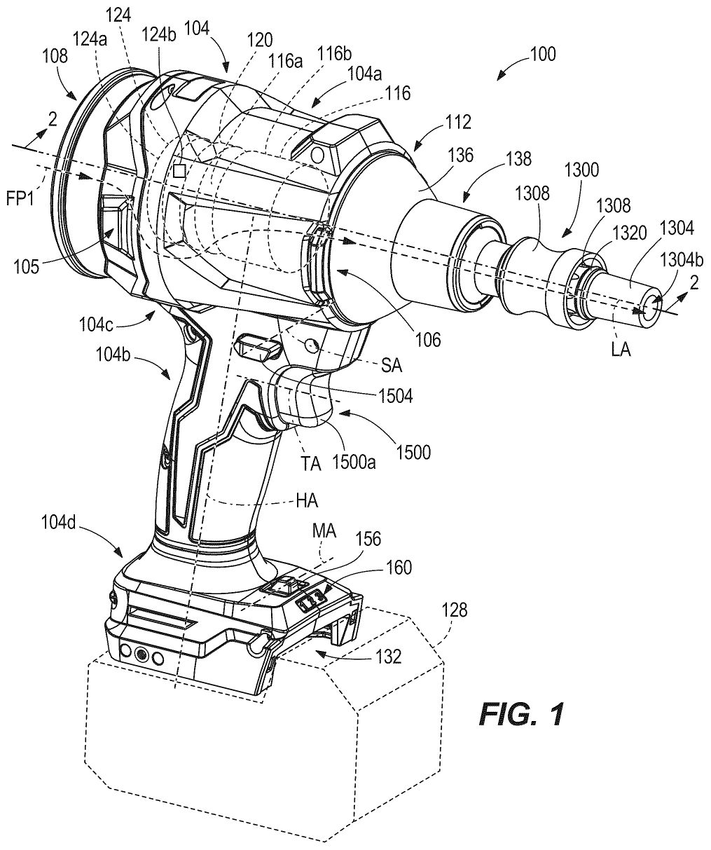

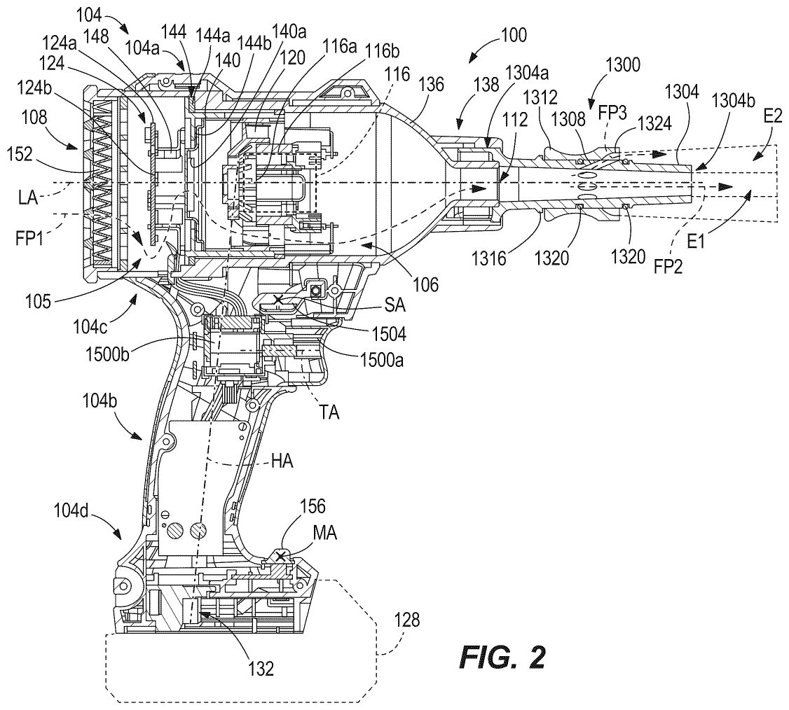

FIGS. 1 and 2 illustrate a blower 100 including a housing 104 defining an inlet 108 and an outlet 112, a motor 116, an impeller 120 coupled to a rotor 116a of the motor 116. The motor 116 is positioned between the impeller 120 and the outlet 112. The housing 104 is generally oriented along a longitudinal axis LA between the inlet 108 and the outlet 112. On activation of the motor 116, electrical current passes through windings in a stator 116b of the motor 116 to cause the rotor 116a to rotate. On rotation of the rotor 116a, the impeller 120 generates a pressure differential and thus airflow passing along an airflow path FP1 from the inlet 108 to the outlet 112. A printed circuit board assembly (e.g., PCBA) 124 is positioned in the airflow path FP1 between the inlet 108 and the impeller 120. As shown in the example of FIGS. 1 and 2, the PCBA 124 is positioned upstream of both the impeller 120 and the motor 116.

The PCBA 124 may include a printed circuit board (e.g., PCB) 124a and at least one heat generating electrical component 124b mounted on the PCB 124a. The electrical component 124b, may be, for example and without limitation, a field effect transistor (i.e., FET) operable to function as a component of an inverter bridge to direct electrical current from a battery pack 128 via a battery receptacle 132 to the motor 116. During activation of the motor 116, the FET may be rapidly and sequentially switched, which generates heat, to transmit electrical power from the battery pack 128 to the motor 116. As the motor 116 is driven, the impeller 120 generates a pressure differential which forces air to enter the inlet 108 and pass through the airflow path FP1. Airflow flowing along the airflow path FP1 may convectively dissipate heat generated by the electrical component 124b to the surroundings of the blower 100. The airflow path FP1 is generally unobstructed through the housing 104 and the airflow has a high velocity and capacity (i.e., high volumetric flow rate) along the airflow path FP1, which improves convective heat transfer from the electrical component 124b to the airflow in the airflow path FP1. With the relative positions of the PCBA 124, the impeller 120, and the motor 116 illustrated in FIGS. 1 and 2, the airflow along the airflow path FP1 is capable of dissipating heat via convection from the PCBA 124 as the airflow reaches or passes through the motor 116.

With reference to FIG. 2, the housing 104 may include a shroud 136 that is disposed inboard of (e.g., closer to the longitudinal axis LA than) the motor housing portion 104a, and a motor case 140 that is disposed inboard of the shroud 136. The shroud 136 may include a coupler 138 adjacent the outlet 112, the coupler 138 configured to selectively secure a nozzle 1300 to the housing 104 at or adjacent the outlet 112. It will be appreciated that the shroud 136 may be optional in some examples of the disclosure.

The motor 116 is disposed in and supported by the motor case 140. The motor case 140 may have an inlet aperture 140a. A printed circuit board mount 148 may secure the PCBA 124 to the motor case 140. A seal 144 may separate the motor housing portion 104a into an upstream portion 105 between the motor case 140 and the inlet 108, and a downstream portion 106 between the motor case 140 and the outlet 112. The seal 144 may, in some embodiments, be a two-part seal including a first seal member 144a and a second seal member 144b. The first seal member 144a may be positioned between the motor case 140 and the shroud 136. The second seal member 144b may be positioned between the printed circuit board mount 148 and the motor case 140. Other sealing arrangements are possible.

The blower 100 may include a filter member 152 positioned adjacent the inlet 108. The filter member 152 may inhibit ingress of debris from within air surrounding the blower 100 from entering being passed through the housing 104. The filter member 152 may include one or more stages of filters. The filter member 152 may be permeable to fluid such as air, and impermeable to debris (e.g., solid particulate matter).

The housing 104 includes a motor housing portion 104a and a handle portion 104b projecting from the motor housing portion 104a. The handle portion 104b includes a proximal portion 104c coupled to the motor housing portion 104a and a distal portion (e.g., a foot) 104d. A handle axis HA passes through the handle portion 104b between the proximal portion 104c and the distal portion 104d. The illustrated handle axis HA is transverse to the longitudinal axis LA (e.g., the handle axis HA may be perpendicular or substantially perpendicular to the longitudinal axis LA). The battery receptacle 132 may be located on the distal portion 104d of the handle portion 104b.

With reference to FIGS. 1 and 2, the blower 100 may include a speed selector 156 and at least two speed selector indicators 160. The speed selector 156 may be movable to various positions to cause the motor 116 to operate at different levels of power for generating different volumetric flow rates of air flowing along the airflow path FP1. In the non-limiting example shown, the speed selector indicators 160 are associated with different airflow rates through the housing 104 and are represented by numbers “1”, “2”, and “3” on an exterior of the distal portion 104d of the housing 104. The illustrated speed selector 156 is positioned on the distal portion 104d of the housing 104 adjacent to the speed selector indicators 160.

The relative position of the speed selector 156 and the speed selector indicators 160 may represent to the user a selected volumetric flow rate for operating the blower 100 on activation of the motor 116. For example, the speed selector 156 may be positioned adjacent the speed selector indicator 160 that is indicative of an airflow rate “1” corresponding to a first volumetric flow rate (e.g., a low flow rate or a high flow rate, or another flow rate) such that, when the motor 116 is activated, the blower 100 discharges the airflow at the first volumetric flow rate. The speed selector 156 may be positioned adjacent to the speed selector indicator 160 that is indicative of an airflow rate “2” corresponding to a second volumetric flow rate (e.g., a moderate flow rate or a high flow rate, or another flow rate) such that, when the motor 116 is activated, the blower 100 discharges the airflow at the second volumetric flow rate that is different from volumetric flow rate “1”. The speed selector 156 may be positioned adjacent to the speed selector indicator 160 that is indicative of an airflow rate “3” corresponding to a third volumetric flow rate (e.g., a low flow rate or a high flow rate, or another flow rate) such that, when the motor 116 is activated, the blower 100 discharges the airflow at the third volumetric flow rate that is different from volumetric flow rate “1” and the volumetric flow rate “2”.

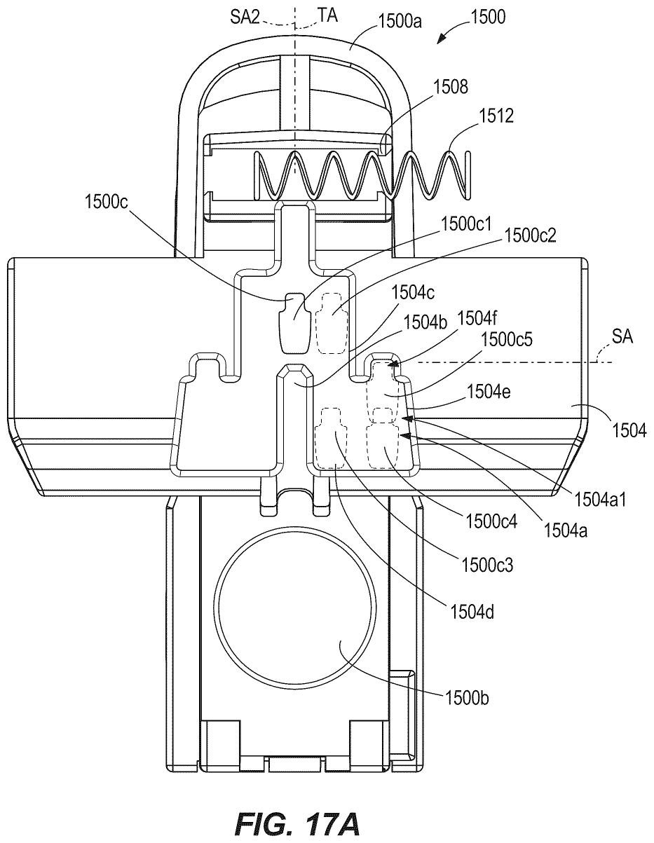

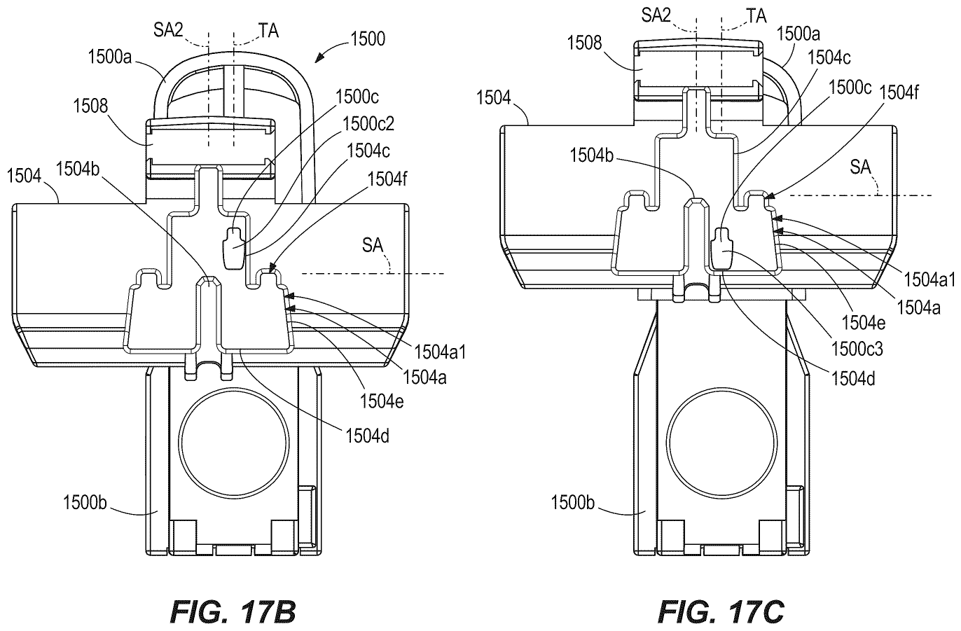

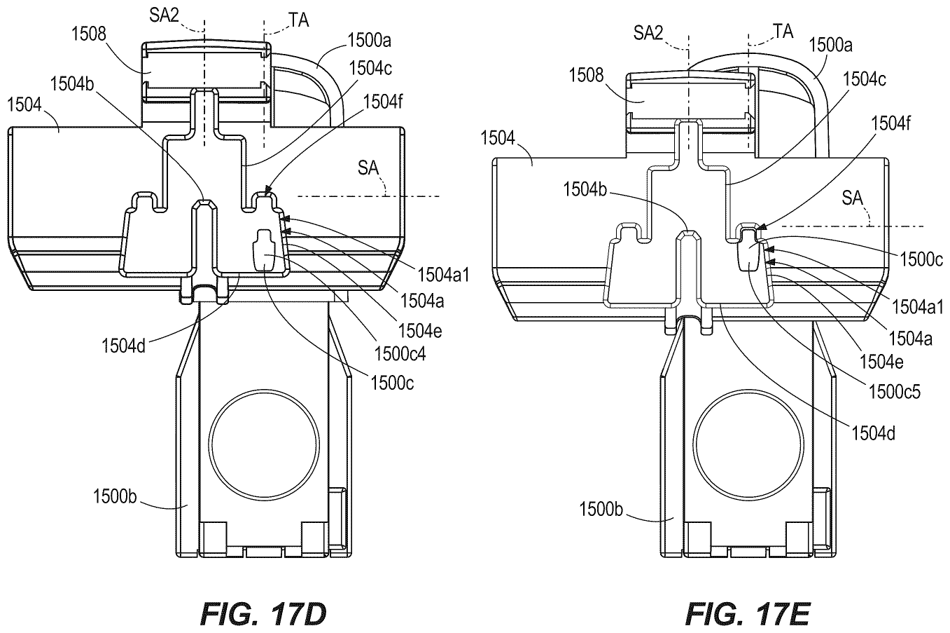

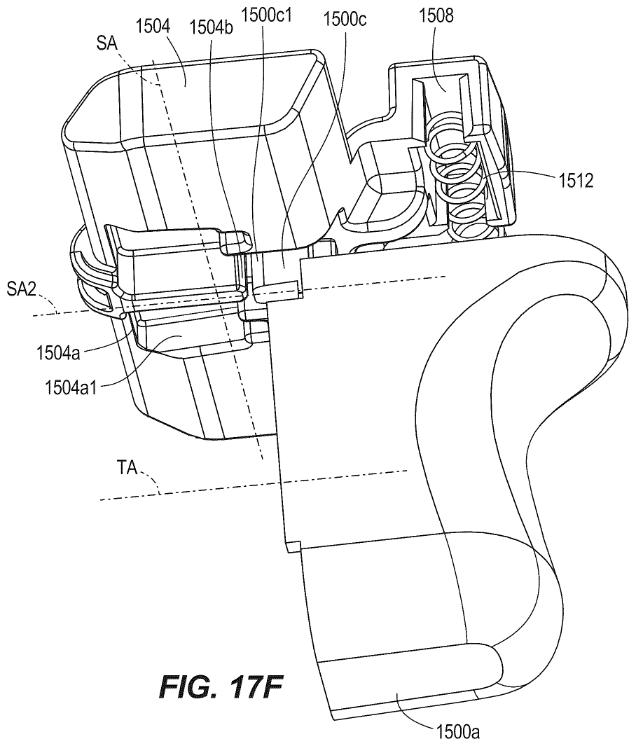

In the illustrated embodiment, the speed selector 156 projects upward from the distal portion 104d in a direction generally along the handle axis HA (as viewed in FIG. 1). In the illustrated example, the speed selector 156 is movable along a movement axis MA which is transverse to (e.g., perpendicular to) and offset from the longitudinal axis LA. In the illustrated embodiment, the movement axis MA is parallel with the shuttle axis SA. While the illustrated position promotes visibility and accessibility of the speed selector 156, the speed selector 156 may be otherwise positioned on the blower 100 for ease of actuation by a user. The blower 100 may include a trigger 1500 and shuttle 1504 as described in detail below regarding FIGS. 17A-17F.

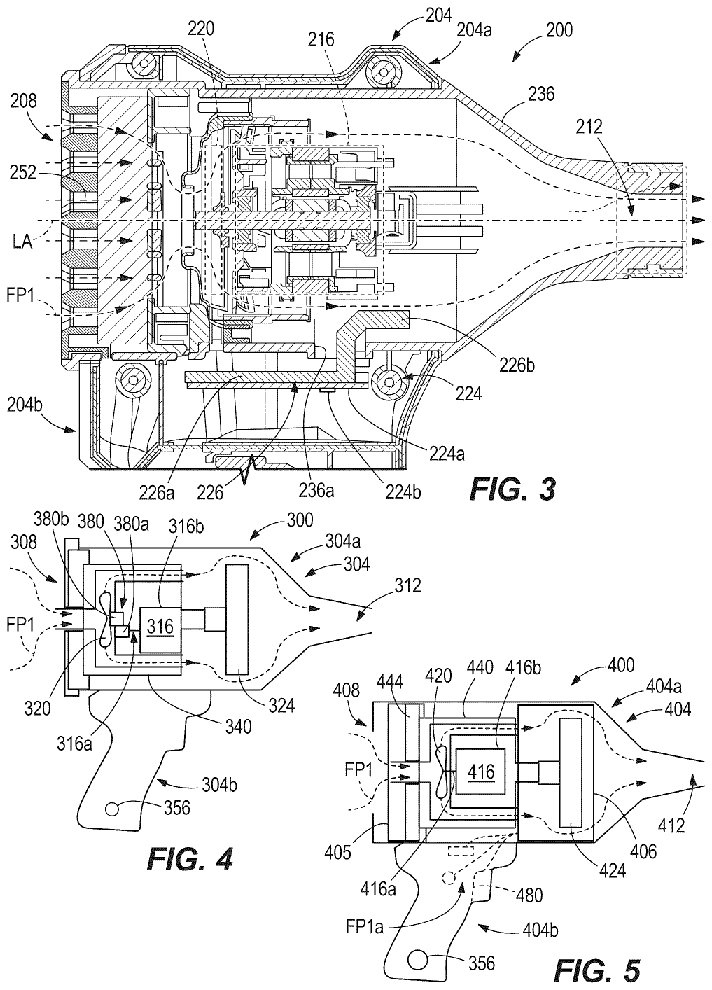

FIGS. 3-13, and 18-21 illustrate exemplary blowers 200, 300, 400, 500, 600, 700, 800, 900, 1000, 1100, 1200, 1400, 1600. Except as described below, each of the blowers 200, 300, 400, 500, 600, 700, 800, 900, 1000, 1100, 1200, 1400, 1600 have features that are similar to or the same as the blower 100 with reference numerals that are incremented to the 200, 300, 400, 500, 600, 700, 800, 900, 1000, 1100, 1200, 1400, or 1600 series of reference numerals, respectively.

FIG. 3 illustrates a blower 200 including a PCBA 224 that is positioned within a handle portion 204b of a housing 204. The shroud 236 of the blower 200 includes a heat sink receiving hole 236a that is located at an interface between the handle portion 204b and a motor housing portion 204a. The blower 200 includes a thermally conductive heat sink 226 having a connection portion 226a thermally coupled to the PCBA 224 and a heat dissipation portion 226b positioned in the motor housing portion 204a. The heat dissipation portion 226b is exposed to the airflow path FP1 such that, on activation of the motor, the heat generated by heat generating electrical components 224b of the PCBA 224 is transferred via conduction from the connection portion 226a to the heat dissipation portion 226b, and the heat is transferred via convection from the heat dissipation portion 226b to the airflow of the airflow path FP1 in the motor housing portion 204a. In the illustrated embodiment, the heat generating electrical components 224b face away from the connection portion 226a with the printed circuit board 224a positioned between the electrical components 224b and the connection portion 226a. However, the electrical components 224b may be located between the printed circuit board 224a and the connection portion 226a, for example, for direct contact between and to facilitate conductive heat transfer between the electrical components 224b and the connection portion 226a.

FIG. 4 illustrates a blower 300 including gears 380 between the motor 316 and the impeller 320. In the illustrated embodiment, the gears 380 include a rotor gear 380a and an impeller gear 380b. The rotor gear 380a is coupled to the rotor 316a of the motor 316. The rotor gear 380a meshes with the impeller gear 380b. The impeller gear 380b is coupled to the impeller 320. Size and number of gear teeth of the gears 380 may be selected to step up or down the speed and torque provided by the rotor 316a and applied to the impeller 320. For example, the rotor 316a may be rotated at 40,000 revolutions per minute (rpm), and the gears 380 may step up the speed of the impeller 320 to 80,000 rpm. Various gear ratios may be utilized. Further, the gears 380 may include any number of intermediate gears (e.g., an intermediate gear, more than one intermediate gear, a gear train) between the rotor gear 380a and the impeller gear 380b. The illustrated gears 380 are positioned physically between the motor 316 and the impeller 320. However, various other relative positions of the gears 380 to the motor 316 and impeller 320 are envisioned. Any of the other blowers 100, 200, 400, 500, 600, 700, 800, 900, 1000, 1100, 1200, 1400 may include gears 380 between the corresponding rotor 316a and impeller 320.

The blower 300 of FIG. 4 includes a PCBA 324 positioned in the airflow path FP1 between the motor 316 and the outlet 312. The PCBA 324 is positioned downstream of both the impeller 320 and the motor 316.

FIG. 5 illustrates a blower 400 including one or more auxiliary inlets 480 in fluid communication with the motor housing portion 404a downstream of the motor 416 and upstream of the PCBA 424. The auxiliary inlet(s) 480 may be positioned on the handle portion 404b and be capable of passing air from the surroundings into the blower 400 to a position downstream of the motor 416 and upstream of the PCBA 424. In the illustrated embodiment, a plurality of auxiliary inlets 480 are positioned on a lateral side of the handle portion 404b. The PCBA 424 is positioned downstream of the motor 416. The PCBA 424 is positioned in a downstream portion 406 of the motor housing portion 404a. A seal 444 between the motor case 440 and the motor housing portion 404a separates the downstream portion 406 of the motor housing portion 404a from an upstream portion 405 of the motor housing portion 404a. Airflow passing along an auxiliary inlet flow path FP1a through the auxiliary inlet(s) 480 is introduced to the airflow path FP1 in the downstream portion 406 of the motor housing portion 404a. In the illustrated embodiment, the PCBA 424 is also positioned in the downstream portion 406 such that both the airflow path FP1 and the auxiliary inlet flow path FP1a pass along the PCBA 424 for convective heat transfer.

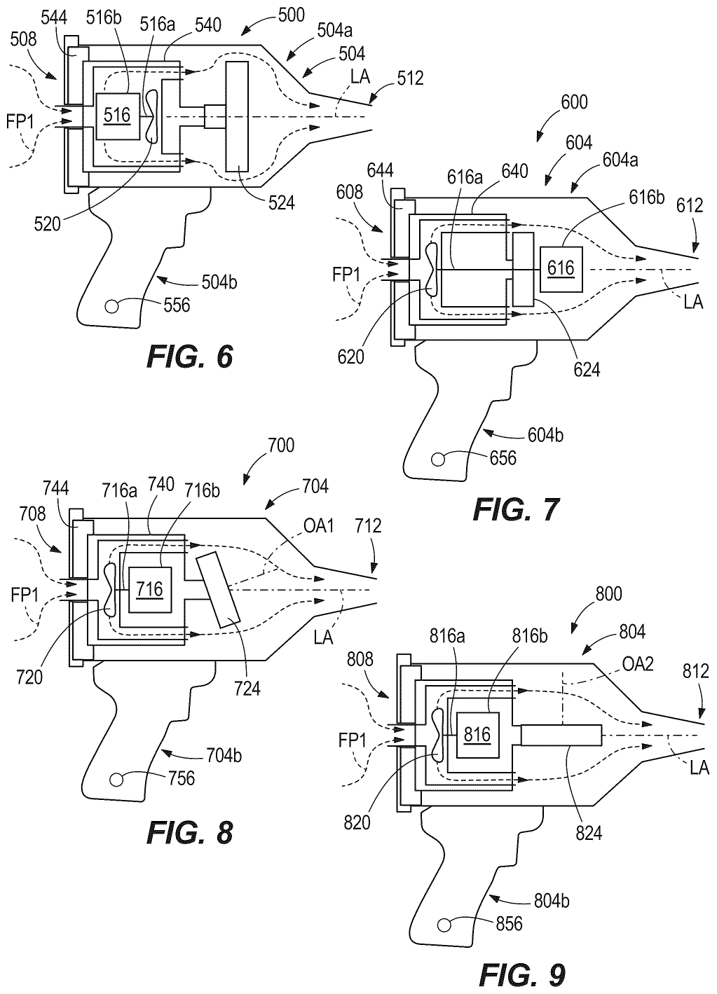

FIG. 6 illustrates a blower 500 including a PCBA 524 positioned in the airflow path FP1 between an impeller 520 and an outlet 512 and a motor 516 positioned between the impeller 520 and an inlet 508. The PCBA 524, impeller 520, motor 516, inlet 508, and outlet 512 are each aligned along a longitudinal axis LA. On activation of the motor 516, airflow along the airflow path FP1 passes from the inlet 508 and along and/or through, in sequence, the motor 516, the impeller 520, and the PCBA 524 to the outlet 512.

FIG. 7 illustrates a blower 600 including a PCBA 624 positioned in the airflow path FP1 between a motor 616 and an impeller 620. A rotor 616a of the motor 616 extends between the impeller 620 alongside or through the PCBA 624. On activation of the motor 616, airflow along the airflow path FP1 passes from the inlet 608 and along and/or through, in sequence, the impeller 620, the PCBA 624, and the motor 616, to the outlet 512.

FIG. 8 illustrates a blower 700 including a PCBA 724 positioned in the airflow path FP1 between the motor 716 and the outlet 712. The PCBA 724 is positioned downstream of both the impeller 720 and the motor 716. The impeller 720, motor 716, inlet 708, and outlet 712 are each intersected by the longitudinal axis LA. However, the PCBA 724 is oriented along an orientation axis OA1 transverse to the longitudinal axis LA. On activation of the motor 716, airflow along the airflow path FP1 passes from the inlet 708 and along and/or through, in sequence, the impeller 720, the motor 716, and the PCBA 724 to the outlet 712.

FIG. 9 illustrates a blower 800 including a PCBA 824 positioned in the airflow path FP1 between the motor 816 and the outlet 812. The PCBA 824 is positioned downstream of both the impeller 820 and the motor 816. The impeller 820, motor 816, PCBA 824, inlet 808, and outlet 812 are each intersected by the longitudinal axis LA. The PCBA 824 may generally be shaped as a rectangular prism. The PCBA 824 is oriented along an orientation axis OA2 perpendicular to the longitudinal axis LA, with its length dimension running parallel to the longitudinal axis LA-left to right as viewed in FIG. 9, its width dimension running perpendicular to the longitudinal axis LA-into the page as viewed in FIG. 9, and its height dimension running perpendicular to the longitudinal axis-up and down as viewed in FIG. 9. On activation of the motor 816, airflow along the airflow path FP1 passes from the inlet 808 and along and/or through, in sequence, the impeller 820, the motor 816, and the PCBA 824 to the outlet 812.

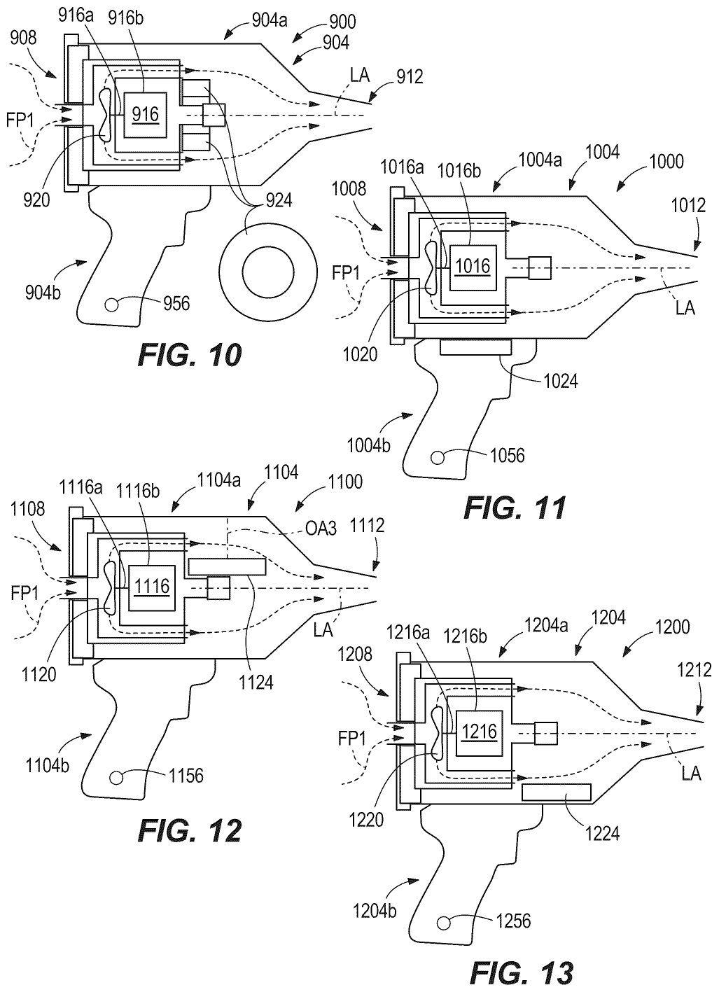

FIG. 10 illustrates a blower 900 including a PCBA 924 positioned in the airflow path FP1 between the motor 916 and the outlet 912. The PCBA 924 is annular in cross-sectional shape perpendicular to the longitudinal axis LA. The PCBA 924 surrounds the longitudinal axis LA. The PCBA 924 is positioned downstream of both the impeller 920 and the motor 916. The impeller 920, motor 916, inlet 908, and outlet 912 are each intersected by the longitudinal axis LA. The PCBA 824 provides a hollow annulus through which the longitudinal axis LA extends. On activation of the motor 916, airflow along the airflow path FP1 may pass from the inlet 908 and along and/or through, in sequence, the impeller 920, the motor 916, and the PCBA 924 to the outlet 912.

FIG. 11 illustrates a blower 1000 including a PCBA 1024 positioned within a handle portion 1004b of a housing 1004. In some embodiments, the handle portion 1004b may be separated from the motor housing portion 1004a such that the airflow path FP1 does not substantially convectively transfer heat from the PCBA 1024. In other embodiments, on activation of the motor 1016, airflow along the airflow path FP1 may pass from the inlet 1008 and along and/or through, in sequence, the impeller 1020, the motor 1016 to the outlet 1012. The airflow path FP1 may pull stagnant air from within the housing 1004 along the PCBA 1024 to convectively cool the PCBA 1024.

FIG. 12 illustrates a blower 1100 including a PCBA 1124 positioned in the airflow path FP1 between the motor 1116 and the outlet 1112. The PCBA 1124 is positioned downstream of both the impeller 1120 and the motor 1116. The impeller 1120, motor 1116, inlet 1108, and outlet 1112 are each intersected by the longitudinal axis LA. However, the PCBA 1124 is offset from, or in other words, not intersected by the longitudinal axis LA. The PCBA 1124 is oriented along an orientation axis OA3 perpendicular to the longitudinal axis LA. The PCBA 1124 is positioned above the longitudinal axis LA such that, on activation of the motor 1116, airflow along the airflow path FP1 passes from the inlet 1108 and along and/or through, in sequence, the impeller 1120, the motor 1116, and along an upper surface of the PCBA 1124 between the PCBA 1124 and the motor housing portion 1104a to the outlet 1112.

FIG. 12 illustrates a blower 1200 including a PCBA 1224 positioned in the airflow path FP1 between the motor 1216 and the outlet 1212. The PCBA 1224 is positioned downstream of both the impeller 1220 and the motor 1216. The impeller 1220, motor 1216, inlet 1208, and outlet 1212 are each intersected by the longitudinal axis LA. However, the PCBA 1224 is offset from, or in other words, not intersected by the longitudinal axis LA. The PCBA 1224 is positioned below the longitudinal axis LA adjacent the handle portion 1204b of the housing 1204 such that, on activation of the motor 1216, airflow along the airflow path FP1 passes from the inlet 1208 and along and/or through, in sequence, the impeller 1220, the motor 1216, and along an upper surface of the PCBA 1224 between the PCBA 1224 and the longitudinal axis LA to the outlet 1212.

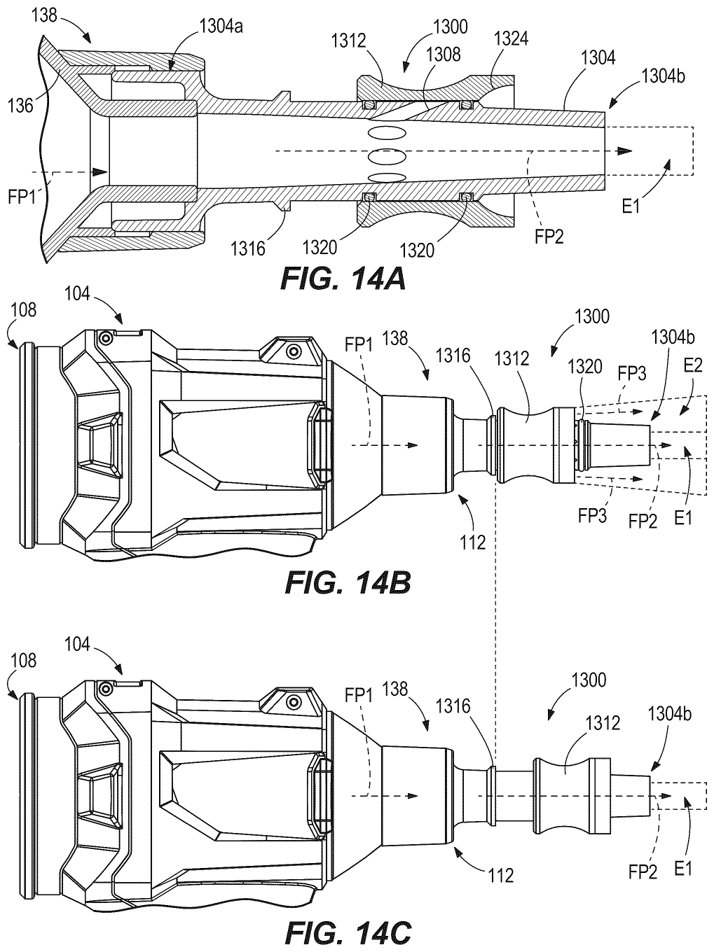

FIGS. 2 and 14A-14C illustrate the nozzle 1300 coupled to the housing 104 via the shroud 136 and coupler 138. The coupler 138 may be actuatable to removably secure the nozzle 1300 and another nozzle (e.g., a replacement nozzle 1300, another nozzle having different geometry or features, etc.) to the housing 104. The coupler 138 may be fixed to the housing 104. The coupler 138, the nozzle 1300, and the another nozzle (e.g., the replacement nozzle 1300) may include complementary and engageable features to facilitate connection and disconnection between the coupler 138 and the nozzle 1300 upon relative movement (e.g., rotation, translation, both rotation and translation, other movement) between the nozzle 1300 and the coupler 138. The complementary and engageable features may function in a similar manner to replacing nozzles on pumps or inflators. Similarly, the coupler 138 may take the form of a chuck including jaws capable of securing the nozzle 1300 to the coupler 138 upon rotation of the coupler 138 to engage the nozzle 1300. The nozzle 1300 includes a generally annular shaped nozzle body 1304 including a proximal end 1304a coupled to the shroud 136 by the coupler 138 and a tip end 1304b spaced along the longitudinal axis LA from the proximal end 1304a when the nozzle 1300 is coupled to the housing 104. The nozzle 1300 may be tapered in an axial direction from the proximal end 1304a toward the tip end 1304b, with the tip end 1304b having a smaller cross-sectional area perpendicular to the longitudinal axis LA than the proximal end 1304a. The proximal end 1304a is configured to receive the airflow passing along the airflow path FP1 at the outlet 112 of the housing 104. The airflow can pass along a second airflow path FP2 from the proximal end 1304a and through the tip end 1304b to exit the nozzle 1300 and to blow airflow from the second airflow path FP2 toward target debris and along an inner egress cone E1.

As illustrated in FIGS. 2 and 14A-14C, the nozzle body 1304 includes a plurality of auxiliary nozzle outlets 1308, and the nozzle 1300 includes a collar 1312. The collar 1312 is movable between a closed position (FIGS. 14A, 14C) that covers the auxiliary nozzle outlets 1308 and an open position (FIGS. 2, 14B) that uncovers the auxiliary nozzle outlets 1308. The closed position prevents air from passing through the auxiliary nozzle outlets 1308, while the open position permits air to pass through the auxiliary nozzle outlets 1308. In the illustrated example, the nozzle 1300 includes a seat 1316 that is integrally formed with and extends outward (e.g., radially outward away from the longitudinal axis LA) from the nozzle body 1304.

The illustrated nozzle 1300 includes a plurality of auxiliary nozzle outlets 1308 circumferentially spaced about the longitudinal axis LA. The auxiliary nozzle outlets 1308 are through holes extending through the nozzle body 1304, and the auxiliary nozzle outlets 1308 are angular relative to the longitudinal axis LA to promote smooth radially outward passage of the airflow along a third airflow path FP3 when the collar 1312 is in the open position (FIGS. 2, 14B). The auxiliary nozzle outlets 1308 need not be oriented precisely at angles intersecting the longitudinal axis LA. The auxiliary nozzle outlets 1308 direct airflow through the third airflow path FP3 to extend in a direction transverse to the longitudinal axis LA.

The collar 1312 is moved forward or advanced from the open position (FIGS. 2 and 14B) to the closed position (FIGS. 14A, 14C) by disengaging the collar 1312 from the seat 1316. As shown, movement to the closed position is toward the right (as viewed in FIGS. 14A, 14C). In the open position (FIGS. 2, 14B), the collar 1312 is in contact or engaged with the seat 1316. In the illustrated example, the nozzle 1300 includes two O-rings 1320 that are outboard of the nozzle body 1304 and inboard of the collar 1312 on either longitudinal side of the auxiliary nozzle outlets 1308 to inhibit undesired air leakage through the collar 1312.

The illustrated collar 1312 includes a tip surface 1324 on its radial inboard surface axially closest to the tip end 1304b. The tip surface 1324 can direct the third airflow path FP3 along an outer egress cone E2 surrounding the inner egress cone E1. In the illustrated embodiment, the tip surface 1324 is a parabolic surface that is revolved about the longitudinal axis LA. In other embodiments, the tip surface 1324 may be otherwise dimensioned. The tip surface 1324 may direct airflow through the third airflow path FP3 to extend in a direction transverse to and/or parallel to the longitudinal axis LA.

While there is no physical boundary between the inner egress cone E1 and the outer egress cone E2, in operating conditions with the collar 1312 in its closed position (FIGS. 14A, 14C), exhaust airflow from the nozzle is generally restricted to flow within the narrower inner egress cone E1 by the geometry of the tip end 1304b. Shifting operating conditions with the collar 1312 in its open position (FIG. 12) causes exhaust airflow to flow within a broader area including both the inner egress cone E1 and the outer egress cone E2. The user can shift position of the collar 1312 to open or close the auxiliary nozzle outlets 1308 and thus select between operation of the blower 100 with the narrower inner egress cone E1 (collar 1312 closed, FIGS. 14A, 14C) for targeted blowing of debris or both the egress cones E1, E2 (collar 1312 open, FIGS. 2, 14B) for broader blowing of debris.

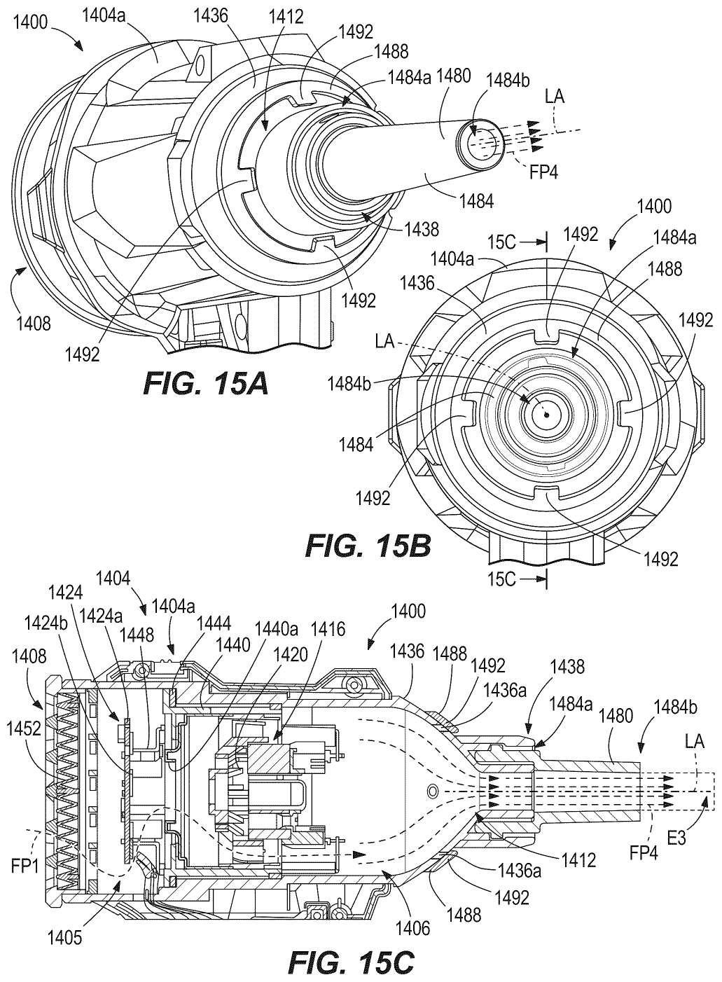

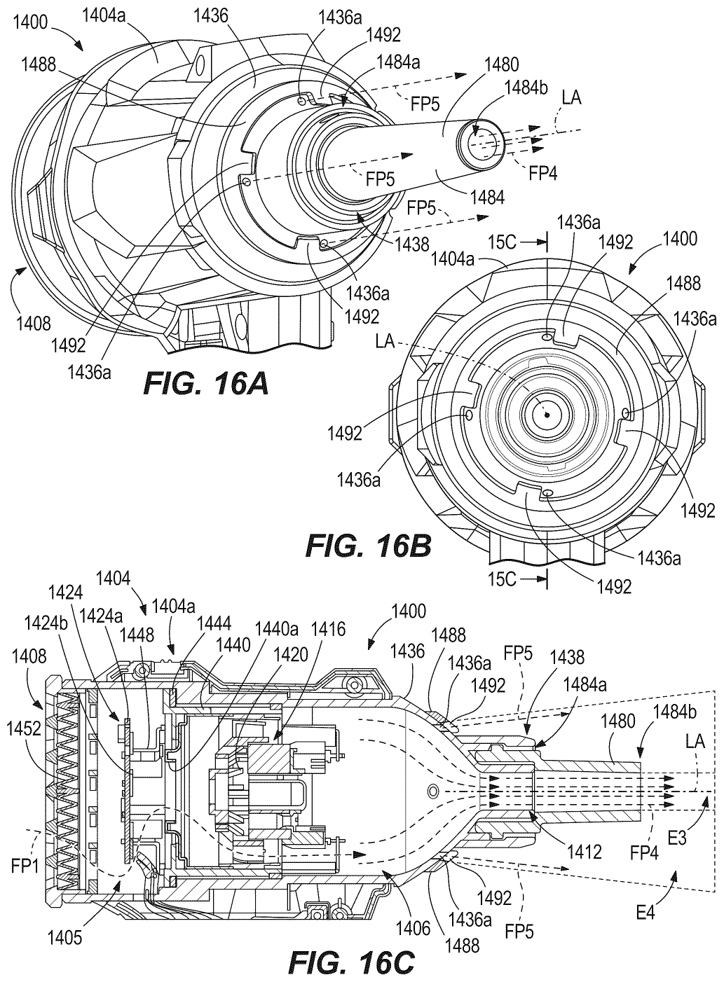

As illustrated in FIGS. 15A-15C and 16A-16C, a blower 1400 with a shroud 1436 including a plurality of auxiliary shroud openings 1436a. The blower 1400 may be couplable to a generally annularly shaped nozzle 1480 including a body 1484 devoid of auxiliary nozzle outlets (like the auxiliary nozzle outlets 1308). The body 1484 includes a proximal end 1484a configured to engage a coupler 1438, and a tip end 1484b spaced along the longitudinal axis LA from the proximal end 1484a.

The blower 1400 includes an adjustable disk 1488 with tabs 1492. The disk 1488 surrounds the shroud 1436 (e.g., the housing 1404) and the longitudinal axis LA. The disk 1488 is rotatable about the longitudinal axis LA between a closed position (FIGS. 15A, 15B, 15C) whereby the tabs 1492 seal the auxiliary shroud openings 1436a thereby inhibiting exhaust airflow through the auxiliary shroud openings 1436a where exhaust airflow passes only along a primary exhaust flow path FP4 through the tip end 1484b, and an open position (FIGS. 16A, 16B, 16C) whereby the tabs 1492 are removed from the auxiliary shroud openings 1436a thereby permitting exhaust airflow to flow through both the primary exhaust flow path FP4 through the tip end 1484b and an auxiliary exhaust flow path FP5 through the auxiliary shroud openings 1436a. The blower 1400 is capable of shifting between the closed position in which airflow passes along an inner egress cone E3, and the open position in which airflow passes along both the inner egress cone E3 and the outer egress cone E4. The auxiliary shroud openings 1436a may direct exhaust airflow through the auxiliary exhaust airflow path FP5 to extend in a direction generally parallel to the longitudinal axis LA. The illustrated embodiment includes a single adjustable disk 1488 with a plurality of tabs 1492 for uncovering a plurality of auxiliary shroud openings 1436a. In the illustrated embodiment, the shroud 1436 includes four circumferentially spaced auxiliary shroud openings 1436a (e.g., evenly spaced openings). In the illustrated embodiment, the disk 1488 includes four evenly circumferentially spaced tabs 1492. Other embodiments may include different numbers of auxiliary shroud openings 1436a, disks 1488, and/or tabs 1492 on a single disk 1488 for adjusting quantity of airflow through the totality of auxiliary shroud openings 1436a depending on the position of each disk 1488. The disk 1488 may be biased to either its closed position or its opened position. Additional structure (e.g., a latch, hook, or other structure) may hold the disk 1488 in one or both of the closed position and the opened position. Various embodiments are possible.

With reference to FIGS. 1-2 and 17A-F, the blower 100 includes a trigger 1500 and a shuttle 1504 for controlling various modes of operation of the trigger 1500. The trigger 1500 includes an actuator 1500a and a trigger switch 1500b. The illustrated actuator 1500a is movable along a trigger axis TA extending generally parallel to the longitudinal axis LA of the motor housing portion 104a. The trigger 1500 may be a set speed trigger only capable of turning on and off. The trigger 1500 may optionally be a variable speed trigger. In such variable speed triggers, movement of the actuator 1500a (e.g., depression via a user's finger) in a direction toward and away from the trigger switch 1500b increases or decreases the motor speed. That is, transmission of electrical power from the battery pack 128 to the motor 116 increases the farther that the actuator 1500a is moved inward (e.g., the electrical power supplied to the motor 116 based on the proximity of the actuator 1500a to the trigger switch 1500b). Conversely, transmission of electrical power from the battery pack 128 to the motor 116 decreases from a maximum when the actuator 1500a moves from an innermost fully depressed position (i.e. closest to the trigger switch 1500b) toward a released position.

With reference to FIGS. 17A-17F, the trigger 1500 includes a trigger structure 1500c (e.g., a trigger tongue or tab) and the shuttle 1504 includes a shuttle structure 1504a that cooperates with the trigger structure 1500c to control actuation of the trigger 1500. More specifically, the shuttle 1504 is movable relative to the trigger 1500 between various positions to control actuation of the trigger 1500 and thus the capability of a user to actuate the motor 116. The shuttle structure 1504a is defined by a pocket 1504a1 that includes a lock surface 1504b, a primary side wall 1504c, an end wall 1504d, a secondary side wall 1504e, and a retainer recess 1504f disposed between the primary side wall 1504c and the secondary side wall 1504e. The shuttle 1504 may include a spring recess 1508 in which a spring 1512 is located to bias the shuttle 1504. The shuttle 1504 may be biased by the spring 1512 to a position in which the lock surface 1504b of the shuttle 1504 is aligned along the trigger axis TA with the trigger structure 1500c of the trigger 1500.

FIGS. 17A-17F illustrate various positions of the trigger structure 1500c relative to the shuttle structure 1504a of the shuttle 1504. These relative positions are illustrated by showing the trigger structure 1500c in positions indicated by reference numerals 1500c1-1500c5. FIGS. 17A and 17F illustrate the trigger structure 1500c in a lock-off position 1500cl, and further schematically illustrates each of the other relative positions of the trigger structure 1500c relative to the shuttle 1504. For clarity, the spring 1512 is illustrated only in FIGS. 17A and 17F. In the lock-off position 1500c1, the trigger structure 1500c is aligned axially along the trigger axis TA with the lock surface 1504b such that the shuttle 1504 functions as a safety that prevents, or substantially prevents, movement of the trigger structure 1500c. More specifically, the lock-off position 1500cl represents a lock-off mode in which the trigger 1500 (more specifically, the actuator 1500a) is inhibited from being actuated by the lock surface 1504b.

From the lock-off position 1500cl, a user may laterally translate the shuttle 1504 along a shuttle axis SA that extends along the long dimension of the shuttle 1504 and that is transverse to (e.g., perpendicular to) the trigger axis TA when viewed in FIG. 17A. During lateral translation of the shuttle 1504, the spring 1512 may be loaded. On sufficient lateral translation of the shuttle 1504, the trigger structure 1500c reaches an initial operational position 1500c2 (FIG. 17B) in which the trigger structure 1500c contacts or is positioned adjacent to the primary side wall 1504c and is trigger structure 1500c laterally offset from the lock surface 1504b. From the initial operational position 1500c2, the actuator 1500a is movable relative to the trigger switch 1500b along a path that is parallel to the trigger axis TA to a fully-operated position 1500c3 (FIG. 17C) of the actuator 1500a. In other words, the path between the initial operational position 1500c2 and the fully-operated position 1500c3 represents an operating mode in which the shuttle 1504 permits actuation of (e.g., depression or release of) the actuator 1500a.

After the actuator 1500a reaches the fully-operated position 1500c3, or is substantially in the fully-operated position 1500c3, the shuttle 1504 can be further laterally translated to a pre-locked-on position 1500c4 (FIG. 17D) whereby the trigger structure 1500c contacts or is disposed adjacent to the secondary side wall 1504e. From the pre-locked-on position 1500c4, (e.g., with the user holding the shuttle 1504), the user may release the actuator 1500a. Upon release of the actuator 1500a from the pre-locked-on position 1500c4, a bias member (e.g., a spring) acting on the actuator 1500a and biasing the actuator 1500a away from the trigger switch 1500b may cause the trigger structure 1500c to move into and engage the retainer recess 1504f in a locked-on position 1500c5 (FIG. 17E). The bias member (e.g., a spring) may apply force to the actuator 1500a to partially retract the actuator 1500a away from the trigger switch 1500b to a partially retracted position corresponding with the locked-on position 1500c5. In this partially retracted position, the actuator 1500a is partially retracted relative to the trigger switch 1500b with the trigger switch 1500b in an “on” condition whereby power is supplied to the motor 116. The trigger structure 1500c physically engages the retainer recess 1504f to hold the actuator 1500a in this partially retracted position. The same biasing member (e.g., spring) typically biases the actuator 1500a toward a fully retracted position (e.g., locked-off position 1500c1, initial operational position 1500c2) in which the actuator 1500a is positioned relative to the trigger switch 1500b with the trigger switch 1500b in an “off” condition whereby power is not supplied to the motor 116. For example, the biasing member may bias the actuator 1500a from the fully-operated position 1500c3 toward the initial operational position 1500c2, where the trigger switch 1500b is in an “off” condition in which no power is supplied to the motor 116 when the actuator 1500a is removed from, or not in, the locked-on position 1500c5 or the pre-locked on position 1500c4. In the locked-on position 1500c5, the trigger 1500 (more specifically, the actuator 1500a) is held in an actuated position by the shuttle 1504 such that a user may remove pressure from the trigger 1500 and release the shuttle 1504. That is, the trigger structure 1500c cooperates with the retainer recess 1504f to hold the actuator 1500a in a position that facilitates continuous activation of the motor 116. The locked-on position 1500c5 represents a locked-on operating mode such that the trigger 1500 (more specifically, the actuator 1500a) is held in an actuated position by the shuttle 1504 and the motor 116 continues operation without requiring the user to depress or hold the actuator 1500a or the shuttle 1504.

The trigger structure 1500c may be moved in reverse sequence from the locked-on position 1500c5 to the locked-off position 1500cl by engagement of the trigger 1500 and the shuttle 1504. That is, a user may engage the trigger 1500 to withdraw the trigger structure 1500c from the retainer recess 1504f (e.g., to the pre-locked on position 1500c4), and the shuttle 1504 can be moved (e.g., by the user or via spring bias) so that the trigger structure 1500c is in the fully operated position 1500c3. Subsequent release of the trigger 1500 moves the trigger structure 1500c to the initial operational position 1500c2, and further lateral movement of the shuttle 1504 (e.g., caused by the spring 1512 or by a user) returns the trigger structure 1500c to the locked-off position.

In the illustrated example, as shown in FIGS. 17A-17F, the shuttle structure 1504a is symmetrical about a secondary shuttle axis SA2, which is perpendicular to the shuttle axis SA. That is, the features of the shuttle structure 1504a that are described above (i.e., the lock surface 1504b, a primary side wall 1504c, an end wall 1504d, a secondary side wall 1504e, and a retainer recess 1504f) are mirrored (e.g., duplicated) on the other side of the secondary shuttle axis SA2. In such an arrangement, the shuttle 1504 may be moved in either lateral direction (e.g., left or right along shuttle axis SA as viewed in FIGS. 17A and 17F) to positions corresponding with each of the three operating modes: the lock-off operating mode (represented by lock-off position 1500c1), the regular operating mode (represented by the initial operational position 1500c2 and the pre-locked-on position 1500c4), and the lock-on operating mode (represented by locked-on position 1500c5).

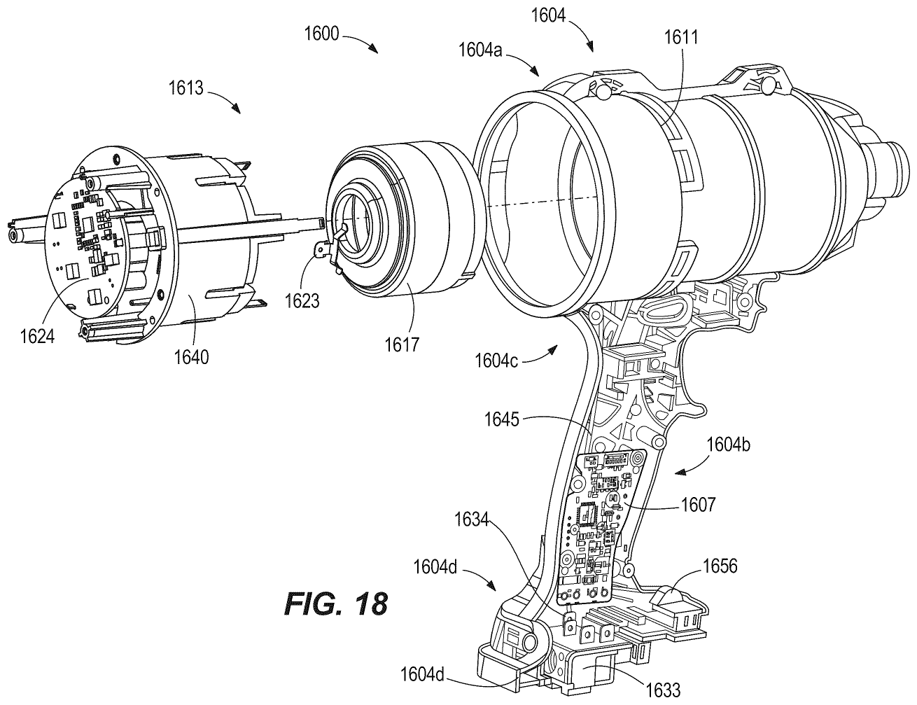

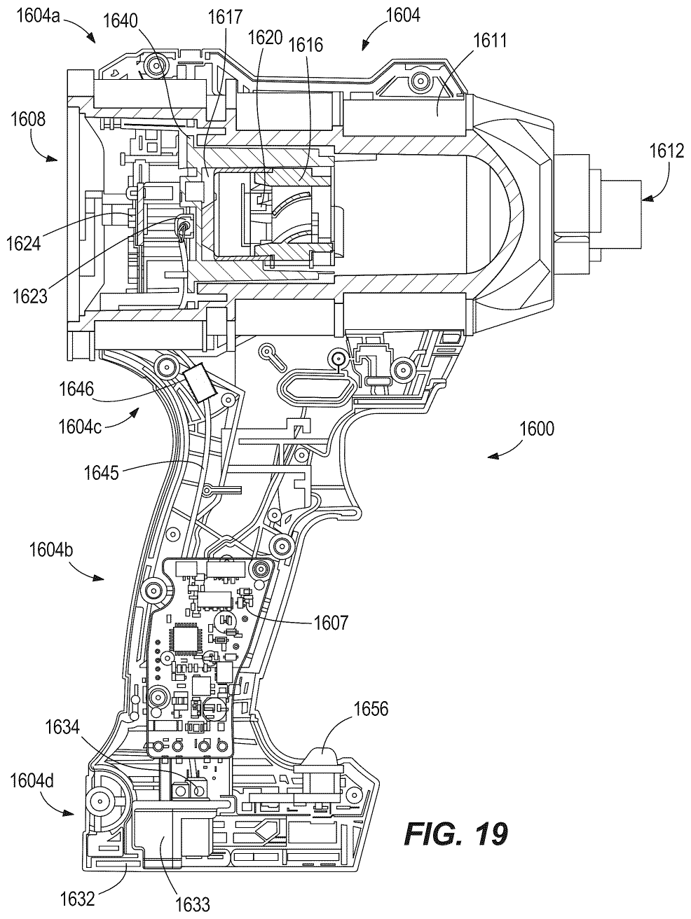

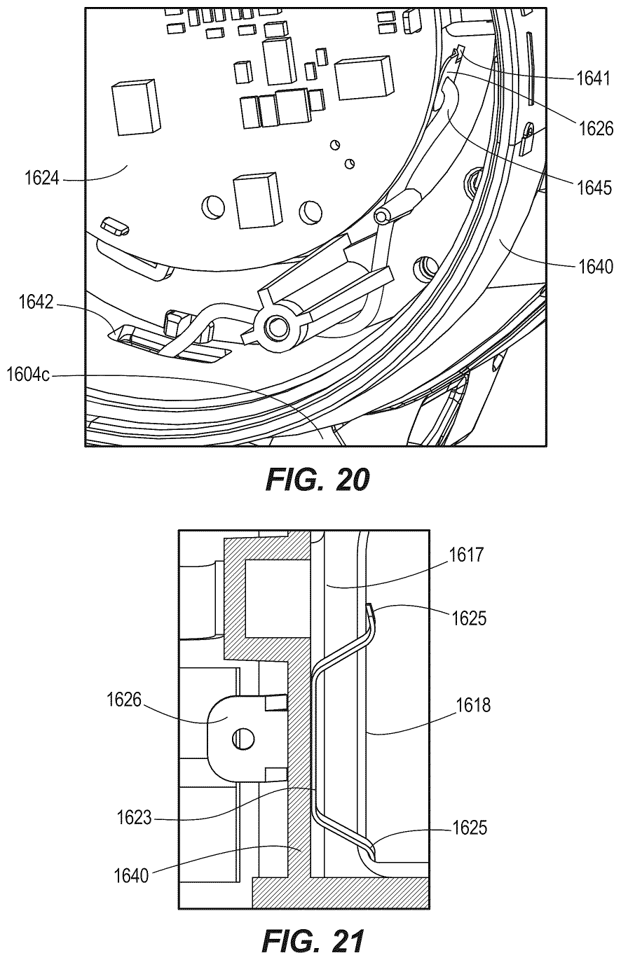

FIGS. 18-21 illustrate another exemplary blower 1600 including a housing 1604 defining a motor housing portion 1604a and a handle portion 1604b extending from the motor housing portion 1604a. The handle portion 1604b includes a proximal portion 1604c coupled to the motor housing portion 1604a and a distal portion (e.g., a foot) 1604d. The motor housing portion 1604a defines an air tube 1611 that forms a shroud to house a motor assembly 1613 that is receivable within the air tube 1611. The motor assembly 1613 includes a motor housing 1617 housing an electric motor 1616, a motor case 1640 having a PCBA 1624, and a clip 1623. The motor housing 1617 and the motor 1616 are disposed in and supported by the motor case 1640 within the air tube 1611. In some embodiments, the motor case 1640 is formed from a polymer, such as plastic. In the illustrated embodiment, the motor 1616 also includes an impeller 1620 (FIG. 19) coupled to a rotor 1616a of the motor 1616. Like the blower 100, during operation of the motor 1616, the impeller 1620 generates a pressure differential to force air to enter an inlet 1608 (FIG. 19) in the housing 1604 and out an outlet 1612 of the housing 1604 to define an airflow path.

The blower 1600 includes a battery receptacle 1632 that is located on the distal portion 1604d of the housing 1604 and that is configured to selectively receive a battery pack (not shown) to provide electrical power to the motor 1616. The battery receptacle 1632 includes a battery terminal 1633 with a plurality of ground pins 1634 for grounding the battery pack when it is coupled to the battery receptacle 1632.

With continued reference to FIGS. 18-21, the blower 1600 also includes a ground wire 1645 extending between the motor housing 1617 and the battery terminal 1633. A first end of the wire 1645 is coupled to the motor housing 1617 via a conductor, such as the clip 1623, and a second end of the wire 1645 is electrically coupled to the battery terminal 1633 via one of the ground pins 1634. On operation of the blower 1600, the impeller 1620 forces air through the housing 1604 along the airflow path. With each interaction between the air forced through the housing 1604 and the blower 1600, a difference between a charge affinity of the blower 1600 and the air induces a static charge within the blower 1600 and, in some circumstances, the motor 1616. If this static charge is not dissipated, the static charge may accumulate over a period of time until the static charge becomes high enough to potentially shock the user or the electronics of the blower 1600. The wire 1645 transfers static charge buildup in the motor 1616, or other areas of the blower 1600, to the ground pins 1634 of the battery terminal 1633 to avoid static charge buildup in the blower 1600.

With reference to FIGS. 19-21, in the illustrated embodiment, the clip 1623 is formed from a metallic material and is mounted within the motor case 1640. In particular, the clip 1623 is mounted within the motor case 1640 such that legs 1625 of the clip 1623 abut an interior surface 1618 of the motor housing 1617, while a tabbed portion 1626 of the clip 1623 extends through an opening 1641 in the motor case 1640 and toward the inlet 1608 of the housing 1604. In the illustrated embodiment, the first end of the wire 1645 is soldered to the tabbed portion 1626 of the clip 1623 and the remaining portion of the wire 1645 is routed through an opening 1642 in the air tube 1611 and down through the handle portion 1604b and past a handle PCBA 1607 to couple the second end of the wire 1645 to the ground pins 1634. In other words, the wire 1645 forms a travel path for the static charge generated by the blower 1600 to follow from the motor case 1640 and down through the handle portion 1604b to the ground pins 1634 on the battery terminal 1633. In some embodiments, the travel path of the wire 1645 is routed through the blower 1600 to not only prevent static discharge to the user, but also to the other electronics (e.g., any of the PCBAs 1607, 1624) of the blower 1600. In other embodiments, the wire 1645 can be attached to the clip 1623 in other ways known in the art.

Additionally, in some embodiments, the blower 1600 also includes an electromagnetic filter 1646 coupled to the wire 1645 and positioned within the travel path to filter and suppress high-frequency noise and interference between the electronic circuits within the blower 1600 or other electronic devices. During use of the blower 1600, the electromagnetic filter 1646 prevents the wire 1645 from acting as an antenna and receiving interference from the electronic circuits within the blower 1600 itself or other electronic devices. In some embodiments, the electromagnetic filter 1646 is a ferrite bead composed of a ferrite ceramic material.

Although aspects of the disclosure have been described in detail with reference to certain preferred embodiments, variations and modifications exist within the scope and spirit of one or more independent aspects as described.

Various features of the invention are set forth in the following claims.

1. A blower comprising:
a housing defining an inlet and an outlet, the housing extending along a longitudinal axis;
a motor within the housing;
a printed circuit board assembly including a printed circuit board and a plurality of heat generating electrical components mounted on the printed circuit board; and
an impeller coupled to the motor and configured to generate airflow passing along an airflow path from the inlet to the outlet on activation of the motor;
wherein the longitudinal axis intersects the motor, the printed circuit board assembly, and the impeller.

2. The blower of claim 1, further comprising a nozzle coupled to the outlet, the nozzle including a body with a plurality of auxiliary nozzle outlets and an adjustable collar movable between
a closed position covering the auxiliary nozzle outlets whereby exhaust from the housing is inhibited from passing through the auxiliary nozzle outlets, and
an open position uncovering the auxiliary nozzle outlets whereby exhaust from the housing is permitted to pass through the auxiliary nozzle outlets.

3. The blower of claim 2, wherein the auxiliary nozzle outlets are through holes extending through the body transverse to the longitudinal axis, and wherein the auxiliary nozzle outlets are circumferentially spaced about the longitudinal axis.

4. The blower of claim 2, wherein, when the adjustable collar is in the closed position, the exhaust from the housing passes through the nozzle forming an inner egress cone, and wherein, when the adjustable collar is in the open position, the exhaust from the housing passes through the nozzle forming an outer ingress cone surrounding the inner egress cone.

5. The blower of claim 1, wherein the housing further comprises a plurality of auxiliary housing outlets and the blower further comprises an adjustable outlet disk movable between
a closed position covering the auxiliary housing outlets whereby exhaust from the outlet of the housing is inhibited from passing through the auxiliary housing outlets, and
an open position uncovering the auxiliary housing outlets whereby exhaust from the housing is permitted to pass through the auxiliary housing outlets.

6. The blower of claim 5, wherein the adjustable outlet disk includes a plurality of tabs for selectively covering the auxiliary housing outlets when the adjustable outlet disk is moved from the open position to the closed position.

7. The blower of claim 1, further comprising a trigger including a structure and a shuttle including a shuttle structure, the trigger structure and the shuttle structure capable of providing each of
a lock-off operating mode whereby the trigger is inhibited from being actuated by the shuttle,
a regular operating mode whereby the shuttle permits actuation of the trigger, and
a lock-on operating mode whereby the trigger is held in an actuated position by the shuttle.

8. The blower of claim 1, wherein the printed circuit board assembly is positioned in the airflow path between the inlet and the impeller, and the motor is positioned in the airflow path between the impeller and the outlet.

9. The blower of claim 1, further comprising
a motor housing portion within the housing including a motor case for supporting the motor; and
a seal positioned within the motor housing portion separating the motor housing into an upstream portion between the motor case and the inlet, and a downstream portion between the motor case and the outlet.

10. A blower comprising:
a housing defining a motor housing portion with an inlet and an outlet, and a handle portion projecting from the motor housing portion;
a motor within the motor housing portion;
a printed circuit board assembly including a printed circuit board and a plurality of heat generating electrical components mounted on the printed circuit board, the printed circuit board assembly positioned within the handle portion of the housing;
an impeller coupled to the motor and configured to generate airflow passing along an airflow path from the inlet to the outlet on activation of the motor; and
a thermally conductive heat sink including a connection portion thermally coupled to the printed circuit board assembly and a heat dissipation portion positioned in the motor housing portion exposed to the airflow path such that on activation of the motor, the heat generated by the heat generating electrical components is transferred via conduction from the connection portion to the heat dissipation portion and the heat is transferred via convection from the heat dissipation portion to the airflow.

11. The blower of claim 10, wherein the housing extends along a longitudinal axis, and wherein the longitudinal axis intersects the motor, the inlet, the outlet, and the impeller.

12. The blower of claim 11, wherein the printed circuit board assembly is laterally offset from the longitudinal axis.

13. The blower of claim 12, wherein the printed circuit board is located outside of the airflow path.

14. The blower of claim 10, further comprising a shroud supported within the motor housing portion, the shroud including a through hole located at an interface between the handle portion and the motor housing portion for receiving the heat dissipation portion of the thermally conductive heat sink.

15. A blower comprising:
a housing defining an inlet and an outlet, and a handle portion projecting from the housing portion, the handle portion including a battery receptacle having a battery terminal with a ground;
a motor assembly within the housing, the motor assembly including
a motor case,
a motor housing supported with the motor case, the motor housing having a motor, and a conductor mounted with the motor case;
an impeller coupled to the motor and configured to generate airflow passing along an airflow path from the inlet to the outlet on activation of the motor; and
a wire electrically coupled to the conductor and the ground on the battery terminal, the wire being configured to route static electricity generated by the motor to the ground of the battery terminal.

16. The blower of claim 15, wherein the conductor is a metallic clip including a plurality of legs and a tabbed portion.

17. The blower of claim 16, wherein the motor case includes an opening, and wherein the metallic clip is mounted within the motor case such that the legs of the clip abut an interior surface of the motor housing, and the tabbed portion extends through the opening.

18. The blower of claim 17, wherein the wire includes a first end electrically coupled to the tabbed portion of the clip and a second end electrically coupled to the ground.

19. The blower of claim 18, further comprising a shroud for supporting the motor case, the shroud including an opening for receiving the second end of the wire.

20. The blower of claim 15, wherein the wire forms a travel path to ground that passes through the handle portion, and wherein the static electricity generated by the motor follows the travel path to ground.
